(19) United States
(12) Patent Application Publication
(10) Pub. No.: US 2010/0042455 A1
(43) Pub. Date: Feb. 18, 2010

(54) MODEL-BASED REAL-TIME COST ALLOCATION AND COST FLOW

(75) Inventors: Jianbo Liu, Warren, MI (US); Stephan R. Biller, Birmingham, MI (US); Qing Chang, Troy, MI (US); Guoxian Xiao, Troy, MI (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., Detroit, MI (US)

(21) Appl. No.: 12/190,275

(22) Filed: Aug. 12, 2008

(51) Int. Cl. G06Q 10/00

(52) U.S. Cl. 705/8

(57) ABSTRACT

A costing process that takes advantage of real-time information about plant floor activities and provides a more accurate and timely financial feedback about the process efficiencies in response to new changes in the process operation. The costing process includes identifying stations that consume resources, consume activities and supply activities. The costing process also identifies a plurality of resources that are provided to one or more of the stations. The costing process also includes identifying resources from the plurality of resources that are used as needed and resources that are supplied in advance of being used. The costing process allocates costs for each resource to each station that the resource supplies, including calculating a cost rate, calculating a cost of used capacity and calculating a cost of unused capacity. The costing process then determines the cost that each station and product uses based on the allocations.

### BACKGROUND OF THE INVENTION

1. Field of the Invention

This invention relates generally to a cost allocation process and, more particularly, to a model-based, real-time cost allocation and cost flow process for a manufacturing facility.

2. Discussion of the Related Art

As manufacturing companies try to adapt to increasing operation complexity, they need a cost management system that comprehensively models this complexity and the interrelationships involved. Motivated by the need for a cost management system that can address issues including external financial reporting, operational control and improvement, and strategic decision making and planning, researchers and practitioners in the field struggle to develop integrated costing systems that can provide more flexible, accurate and timely cost information.

Various costing methodologies have been developed and practiced in the past for specific purposes. Some are for the purpose of external financial reporting and regulation compliance, such as traditional cost accounting (TCA), while others, such as activity-based costing (ABC), are solely developed to help managers understand product and customer profitability and identify high-impact areas for process improvement. The intended purposes of the costing methodologies have great impact on the development of underlying costing philosophy and this often limits its capabilities to the designed purposes. As a result, different costing systems have often been applied in isolation due to the fundamental differences in their underlying costing philosophy and the subsequent difficulties in their integration and mutual communication.

The fundamentally different purposes require different levels of accuracy, granularity and timeliness. Operational control and improvement requires detailed information about process efficiencies. Immediate feedback from the process upon implementing new control policies is essential to its success. Therefore, operation control and improvement emphasizes more on the accuracy and timeliness of costs and profitability information. On the other hand, strategic decision making and planning aims to achieve better long-term profitability and requires less accuracy. The underlying justification is that managers can still make sound decisions on the basis of approximate cost information. These seemingly conflicting objectives impose difficulties on developing a single comprehensive costing system that is adequate for all managerial purposes.

It is not infeasible to design a costing system that can fulfill both purposes. Early attempts to adapt activity-based costing methodologies for continuous improvement have been shown in the art. It seems reasonable to attribute the initial success of these costing systems to their scalable structures, which capture the changes in the “dynamics” of a business process in any desired level of detail through aggregation and disaggregation.

Moreover, a thorough understanding of the dynamics of business process and causal relationships among business activities is indispensable for designing a comprehensive costing system to cope with this complexity. The causal relationships among the business functional units provide vital information about the cost flow in the business process. Therefore, it is essential to fully utilize such information when a comprehensive costing system is designed.

From dedicated mass production systems to flexible and reconfigurable manufacturing systems, automotive manufacturing systems have been undergoing dramatic paradigm shifts in response to the aggressive global competition and rapid changes in process technologies. Information technologies, including computing and communication technologies, provide techniques for managing the increasing complexity that is characterizing manufacturing processes, products and enterprises.

Information technology plays an ever increasing important role in modern automation systems. Key elements of manufacturing information infrastructure include database and information management systems, data communications networks and associate services, and management of application software. The modern manufacturing system has long depended on sensory devices and technologies, such as accelerometers and radio frequency identification (RFID), to provide real-time feedback about plant floor activities deriving manufacturing processes. Without continuous developments in microcomputers and programming logic controllers (PLC), today's manufacturing systems would have a completely different picture. Within factories, communication is facilitated by standard protocols or interfaces, such as controller area network (CAN) and Ethernet, for purposes of control, diagnosis, material handling and maintenance dispatching.

With the extensive employment of computer information technologies in the factory floor, the information about the production process and plant floor activities can become readily available in real-time. That real-time information is traditionally used for operational control, such as dynamic scheduling, dispatching and routing, and has not been fully utilized for costing. The availability of such real-time information about plant floor activities provides an opportunity to develop a costing system that provides more accurate and timely financial feedbacks about the process efficiencies.

Traditional cost accounting (TCA) is developed mainly for the purpose of external financial reporting. Unlike activity-based costing (ABC) systems, which focus on activities during the costing process, TCA systems trace cost to products, and therefore, only use attributes of individual product item, such as direct labor hours, machine hours and material dollars, as common bases to allocate manufacturing overhead. In TCA, both direct manufacturing costs (direct labor and raw materials etc.) and manufacturing overhead (indirect materials, equipment lease and depreciation etc.) are allocated to products based on volume-based cost drivers as mentioned above. Other costs, such as administrative cost, are not considered part of the product cost and are classified as period cost.

The implicit assumption underlying TCA is that the manufacturing overhead is strictly proportional to the allocation base being used. In practice, however, the non-proportionality can arise in various ways, such as diversities in production volume, size, complexity, material and setup, which in turn introduce distortions to the reported product costs. Consequently, TCA is only appropriate for organizations that mass produced a narrow range of products and incurred mostly variable costs that are proportional to the production volume.

To overcome the distorted product cost inherent to the traditional volume-based cost system, ABC systems focus on activities instead of products and calculate the cost of a product as the sum of the cost of all the activities required to manufacture and deliver the product. It is clear from the definition that ABC systems assume that the product does not consume resources directly. Instead, it dictates a two-stage procedure in which resources are first consumed by activities and then activities are consumes by products.

An ABC system may use many bases to allocate the cost to the products. Some of the bases are used to trace inputs whose consumption does not vary in proportion with the number of items produced. These additional cost allocation bases enable the ABC system to reduce the distortions introduced by the economic non-proportionality inherent to the production process, and help the ABC system avoid the tendency of over costing high volume and low complexity products while under costing low volume and high complexity products in traditional cost systems.

The accuracy of the cost obtained through an ABC system highly depends on the granularity of activities identified during the design stage of the system. In general, disaggregating activities tends to generate more detail and also more work to gather and interpret data. On the other hand, aggregating activities tends to reduce the work required to gather and interpret data but creates ambiguity in relating costs to activities. An ABC system is only justified when the costs of installing and operating such a system are more than offset by its long-term benefits. Three factors, namely the cost of measurement (those costs associated with the measurements required by the cost system), the costs of errors (those costs associated with making poor decision based on inaccurate product costs), and the diversity of products offers, all play an important role in the justification of implementing an ABC system.

Despite ABC systems apparent advantages over traditional costing system, a conventional ABC system is not widely employed by companies due to the complexity and difficulties in its implementation and maintenance. This is evident from the difficulties encountered in the pioneering efforts of implementing an ABC system in manufacturing plants. Several reasons are cited to explain the failure of an ABC system at the plant level. Managers found that the ABC system is too complex for anything other than product costing and had difficulty relating it to operating decisions. Moreover, the model built earlier based on actual cost data quickly became obsolete. One major reason that might cause those difficulties in implementing and maintaining the ABC system is probably the inappropriate way of organizing different activities, in which the natural ordering and casual relationships among activities are largely unexplored.

Different variations of ABC systems have been developed in the literature to accommodate those difficulties in implementing and in maintaining an ABC system, such as a time-driven ABC (TDABC) system. The TDABCE avoids the costly, time-consuming, and subjective activity-surveying task of conventional ABC systems by using time equations whose parameters are rather easy to measure and update. TDABC systems provide a cost/profitability model that can be adjusted rapidly and inexpensively to the changes in the operating and external environment simply by adding terms in the time equations.

It is pointed out that for decisions with short time horizons, ABC systems fail to distinguish between fixed and variable cost and fully absorbs cost that is partially sunk. This makes ABC systems seemingly inappropriate for making short-term decisions since the sunk cost has already been incurred, and thus should be disregarded when facing the decision at hand. Instead, an ABC system is commonly perceived to be more appropriate for making long-term strategic decisions, such as pricing and product mix. This perception probably arrives from the usual belief that all cost can be considered variable in the long run. Since ABC systems model consumption rather than spending, in the longer run adjustments can be made to bring spending into alignment with consumption.

However, simply labeling ABC systems as a long-term decision making tool seems to be misleading as well. Various adaptations of an ABC system have been developed to preserve process cost information for supporting decision makings in operation control, such as continuous improvement, which is rather short-term. Examples includes the use of micro- and macro-activities to provide process view and cost assignment view of the ABC system, and the process-based activity architecture that can associate activity costs directly with business process.

The idea of throughput accounting (TA) can be traced back to Goldratt's theory of constraint (TOC). The initial idea is originated from Goldratt's earlier work in production scheduling under inherently finite production capacity. Goldratt's view toward traditional cost accounting measures leads to several earlier works on adopting the idea of the TOC in transforming accounting practices.

Goldratt believes that sound decision can be made by examining three global measurements, namely, throughput, inventory and operating expense. The TOC views throughput as the rate at which the system generate money through sales. The concept of throughput is different from the traditional definition of productivity, which is simply the product completely per unit of time. In the TOC, a product's throughput is its selling price minus its totally variable cost whose variation is directly proportional to the variation in production volume.

Throughput=Selling price−Totally variable cost

Clearly, whether to classify a cost item as a totally variable cost generally depends on the nature of operation. However, in most practical occasions, one can define throughput as sales less material costs and regard all non-material costs (including direct and indirect labor, machine depreciation, carrying costs etc.) as operation expenses, which is defined as all the money the system spends in turning inventory into throughput.

Inventory defined in the TOC also differs significantly from the traditional accounting measure of work in progress (WIP) and finished goods inventory. First of all, in the TOC thinking, adding value to the product does not help to achieve the “goal”, (“making money”, i.e., increasing throughput while simultaneously reducing both inventory and operating expense) of the company, since value-added analysis only concerns the product rather than the company. As a consequence, the TOC believes adding value to products is a distorted local optimum and the product stock should be value at material cost only. Second, quite contrary to intuition, Goldratt's definition of inventory also includes all investments that can be sold. For example, the portion of investment that remains in the machines after depreciation is part of the inventory. Unlike just-in-time (JIT) manufacturing that tries to achieve zero WIP inventory, the goal of the TOC aims to minimize WIP inventory rather than completely eliminating it. The TOC advocates stock buffers to protect the bottleneck facilities.

These three global measurements are sufficient to calculate net profit and return on investment (ROI) as:

$$Net profit = Throughput - Operation expense$$

$$R O I = \frac{Throughput - Operational expense}{Inventory}$$

Therefore, to measure the impact of a decision on a company's profitability, the cost of products need not be calculated, which is fundamentally different from TCA and ABC. The focus of the TOC is to maximize throughput while simultaneously reducing inventory and operational expenses. Since the throughput is the primary focus of the TOC, the accounting system inspired by TOC is usually referred to as throughput accounting.

In the TOC thinking, any system in reality must have at least one constraint and the system wise throughput is determined by the system's weakest link, particularly, the constraints or bottlenecks. The TOC believes that the system wise throughput improvement can be achieved by focusing decision making on better managing system constraints or bottlenecks to achieve as much throughput as possible. Non-bottlenecks can be left idle even though it might lead to low local efficiency and utilization, because high utilization of non-bottlenecks does not directly improve the throughput and might create excess work in process inventory instead. The TOC believes that employment of local efficiency and utilization measures and the standard accounting practices of recovering overhead into stock as goods produced can encourage sub-optimal behavior. This is contrary to the assumption made by ABC advocates, that continuous improvement in local efficiency everywhere in the business process will eventually lead to increased profitability since in the long-run all of a company's resources are equally important.

Some researchers and practitioners have started to explore the opportunities of integrating the strengths of various costing strategies. Examples include integration of ABC and TA/TOC, ABC and operational control system, ABC and German cost management system (resource consumption costing). The promise of the integrated system is its potential to deliver far greater benefits than the systems could provide if operated independently.

Despite their differences, TOC and ABC can still be used together to facilitate decision makings. The TOC advocates focusing decisions on bottlenecks or constraints. An ABC system can provide information necessary to choose the best among different strategies, such as product mix and resources reallocation, to eliminate the bottleneck. In addition an ABC system can help to identify bottlenecks or constraints. Activities that have no unused capacities are potential constraints or bottleneck. Therefore, the problem seems to be the trade-off between the extent to which the two approaches are incorporated and the ease of integration.

Resource consumption accounting (RCA) blends the advantage of a robust German cost management system with activity based costing. RCA is based on quantity structure, which means that all consumption relationships are defined on the basis of quantities. Dollar values follow those quantities, but are not used in defining the consumption relationships. As a result, in the operational budgeting process, RCA enables the calculation of both the required resource quantities and the associated dollar value for planned activity quantities. Unlike conventional ABC systems that treat all costs as being variable, RCA clearly differentiate between fixed and variable costs. The cost-assignment rates for fixed costs are based on theoretical capacities and those for variable costs are based on planned quantities.

### SUMMARY OF THE INVENTION

In accordance with the teachings of the present invention, a costing process is disclosed that takes advantage of real-time information about plant floor activities and provides a more accurate and timely financial feedback about the process efficiencies in response to new changes in the process operation. The costing process includes identifying production activities that directly contribute to the completion of a product and supporting activities that do not directly contribute to the completion of the product, but are essential for normal operation of a production process. The costing process also includes identifying stations that consume resources, consume activities and supply activities, such as production stations, maintenance stations and material handling stations. The costing process also identifies a plurality of resources that are provided to one or more of the stations, such as direct labor, equipment depreciation, electricity, equipment lease, maintenance materials, indirect labor, compressed air and direct materials. The costing process also includes identifying resources from the plurality of resources that are used as needed and resources that are supplied in advance of being used. The costing process allocates costs for each resource to each station that the resource supplies, including calculating a cost rate, calculating a cost of used capacity and calculating a cost of unused capacity. The costing process then determines the cost that each station and product uses based on the allocations. In one non-limiting embodiment, the costing process and model also interfaces with real-time plant floor measurements and allocates cost based on those measurements.

Additional features of the present invention will become apparent from the following description and appended claims taken in conjunction with the accompanying drawings.

### BRIEF DESCRIPTION OF THE DRAWINGS

FIG. 1 is a block diagram of a manufacturing plant floor operation;

FIG. 2 is a building block for cost allocation;

FIG. 3 is a flow diagram showing cost allocation and cost flow;

FIG. 4 is a block diagram of a cost flow model for the system shown in FIG. 1; and

FIG. 5 is a block diagram of a portion of the cost flow model showing FIG. 4 giving an example for calculating indirect labor.

### DETAILED DESCRIPTION OF THE EMBODIMENTS

The following discussion of the embodiments of the invention directed to a system and method for providing cost flow operations in a plant is merely exemplary in nature, and is in no way intended to limit the invention or its applications or uses.

In general, plant floor activities can be classified into two categories, namely production activities and supporting activities. Production activities are those activities that directly contribute to the completion of the product. Typical examples of production activities in an automotive manufacturing plant include installation of an air bag, welding the front door panel of the vehicle, etc. Supporting activities do not directly contribute to the completion of the product, but are essential for normal operation of the production process. Maintenance and material handling are two major supporting activities on a plant floor. It is inevitable that subjectiveness will be introduced into the process of identifying the activities and their interrelationships. Depending on the granularity of activities identified during the design stage of a costing process, the accuracy of the resulting costing process would differ. In general, the finer the granularity of the activities, the higher the accuracy of the cost information. However, finer granularity also leads to higher cost of measurements and more difficulties for the system to be updated and maintained.

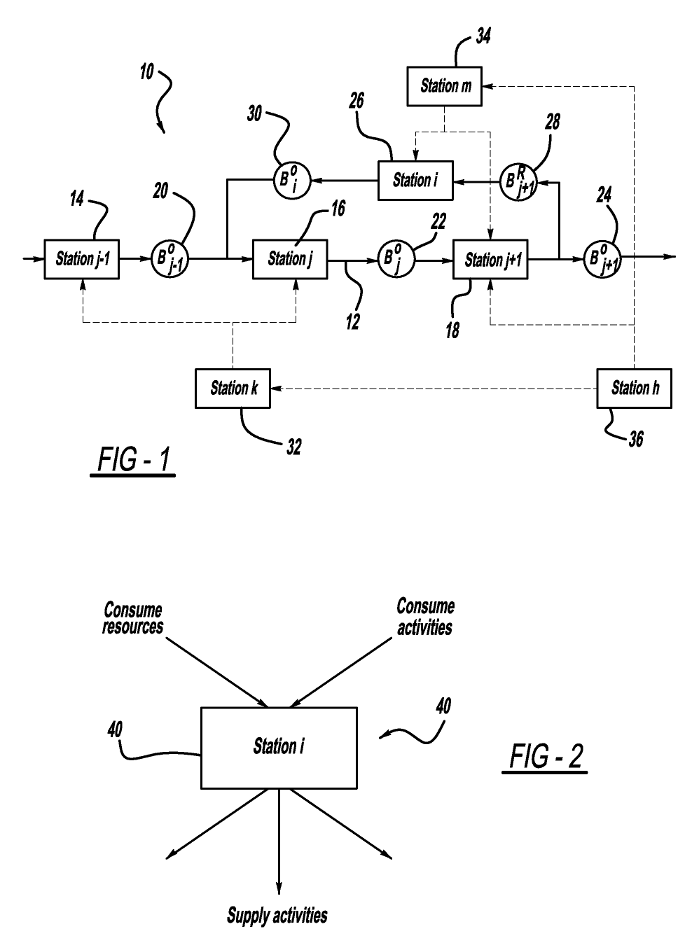

FIG. 1 is a block diagram of a production facility 10 showing plant floor activities including a transfer line 12 and its interrelationships with supporting activities. The production facility 10 also includes three production stations 14, 16 and 18 positioned along the line 12. A buffer area 20 is provided after the station 12, a buffer area 22 is provided after the station 16 and a buffer area 24 is provided after the station 18. The buffer areas 20, 22 and 24 provide part storage locations where parts are waiting to be used in the next station along the line 12. If any part is defective or needs additional work, production station 26, with buffer areas 28 and 30, allows parts to be returned back down the line 12. The production facility 10 also includes a material handling station 32 that provides materials for the production station 14 and 16, a material handling station 34 that provides material handling for the production stations 18 and 26, and a maintenance station 36 that provides maintenance for the material handling stations 32 and 34 and the production station 18.

At the plant floor, a transfer line usually consists of numerous production stations connected in a serial or parallel fashion. Note that a production station is a loose term to represent the provider of a group of micro-activities that need to be performed on a single product item before the next group of activities can be performed. A production station can be an automatic robotic welding cell or a manual assembly station. To avoid the ambiguities when interpreting those activities, and most importantly, to organize those activities in an orderly fashion, one can use the already well defined stations at the plant floor. It is noticeable that this notation of stations is similar to that of macro-activities, which are referred to as aggregations of related micro-activities. Moreover, each station can also be viewed as a responsibility center.

Production stations or activities are interconnected. In a serial transfer line, production activities have to be performed according to the order determined by the lines physical configuration. Starvation and blockage can occur to a production station when there is no product item available from an immediate previous station or there is no empty space down-stream to place the finished product item. As a result, extended down time of a single station can quickly propagate to other station, and in the worst case stop the whole transfer line. This is consistent with the TOCs understanding of the production process that the system wise throughput is determined by its weakest link, i.e., the bottleneck. To keep a continuous and smooth operation of the transfer line and alleviate the negative impact of process variations, buffers are commonly placed between the stations.

Supporting activities also have a great impact on the performance of the transfer line. As mentioned above, maintenance and material handling are two major supporting activities on the plant floor. Equipment breakdown is inevitable to a production process. Without prompt repair, the normal operation of a whole production process can be interpreted due to the close interrelationships among the production activities and supporting activities. To reduce the down time caused by machine failures and to maximize throughput, maintenance has to be performed on a regular basis.

Material handling is the process of transporting raw materials from the docking area to the station where the raw materials are consumed and transformed to products. Without timely delivery of direct materials, the production could be interrupted due to part starvation. Similar with the notation of the production station, the notation of a supporting station is used to denote the provider of a group of supporting activities whose measures of activity levels are roughly proportional. For example, a combination of a fork lift and a driver can be viewed as a supporting station responsible for transporting required materials to a group of production stations commonly known to the plant floor as a zone.

For a given time interval of interest, the cost incurred at a production station is defined as the sum of cost of all activities that are consumed at that station. The total cost incurred includes the cost of the stations corresponding production activities that are directly traceable to the product and the cost of supporting activities that are necessary to keep the normal functioning of the production station. The same rule is also applicable to supporting stations. For example, equipment used for material handling also requires regular maintenance, thus consuming maintenance activities. Therefore, the cost incurred at a material handling station not only includes the cost of resources it consumed directly, such as labor, electricity and lease of the fork lift, but also includes the cost of activities it consumed, such as the maintenance cost.

In order to allocate the cost of resources properly into products or stations, a clear picture of paths along which the cost flows is needed. Two steps are essential to mapping the cost flow. First, to thoroughly explore the internal supplier-consumer relationships of activities in the business process. Second, to formalize those knowledge's hint to a dependency model. The reason why the existence of such a model is provided is that each activity in the system has its functional purposes and is often performed by a responsibility center, such as a station, which consumes resources and other activities.

A station is used as the fundamental building block for constructing the cost flow model from resources from products or stations. FIG. 2 shows a station 40 as a building block and its possible connections with other components in the model. The station 40 is the supplier of an activity or a group of activities to other stations or products. If a group of activities are provided, they have to share a single cost driver, such as volume, man hours or machine hours. The station 40 can not only consume resources, but also activities. The common perception that activities and activity centers only consume resources directly does not allow the dependencies or interrelationships to be encoded. By acknowledging that stations also consume activities, the complex dependencies or interrelationships among activities can be encoded into the structure of the cost flow model.

By appropriately redefining the function of stations, the cost model can be reconstructed in parallel the business process functional or organizational structure, so that the business process can be analyzed in any desired level of detail through aggregation and disaggregation. For example, production stations can be grouped together to represent the production department. This flexible structure provides a multi-dimensional and hierarchical view of the business process, which can be a great help to identify impact areas for continuous improvements.

Resources have been classified into two categories, namely, resources that are used as needed, and resources that are supplied in advance of usage. In the case of the first category, the cost of resources supplied would generally be equal to the cost of resources actually used. This type of recourse is often referred to as a variable cost and has no unused capacity. For example, materials and utilities belong to the first category The cost of the second category of resources refers to the cost committed to making the resources available no matter whether the resources will be fully used for current or future activities. For example, salary and hourly employees, depreciation of equipment in the buildings, and lease of buildings and equipment, etc.

Similar resources can be aggregated into a single recourse pool if they share the same resource cost driver and their resource types are the same. The cost of unused capacity for the resource pool is the difference between the cost of resources supplied and the cost of resources used.

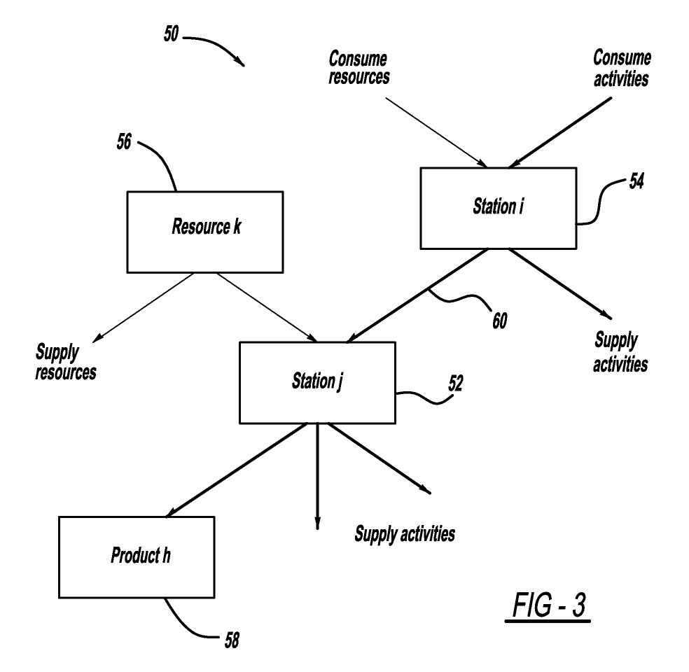

FIG. 3 is a block diagram of a system 50 showing cost allocations and cost flow. As shown, because each resource pool will supply resources to a group of stations, the cost of resources used for the resource pool is the sum of the costs of resources consumed by different stations from the same resource pool. The system 50 includes two stations 52 and 54 similar to the station 40 that consume resources and activities and supply activities. The system 50 also includes a resource 56 that supplies resources to the station 52. Also, the system 50 includes a product 58 that is made by the station 54. Connecting arcs 60 between the stations identify a particular thing and have a certain weight, as will be discussed in more detail below.

In the short-term, the resources that are supplied in advance of usage can be view as fixed. In the TOC thinking, especially in the case of labor, because a company cannot hire or fire an employee arbitrarily, the problem actually becomes how to manage unused capacity supplied by the resources. Using both financial and non-financial measures to track the unused capacity the changes in demands for activities as a function of product volume, product mix, process improvements and changes in product and process design can be predicted. Decisions can then be made to achieve a better balance between the amount of resources to be committed and activity demands in the forth coming periods. In the long run, with appropriate decision feedback, the resources that are supplied in advance of usage but match the actual demands and therefore can also be viewed as variable.

The same basic principals can be applied for resource classification to activities. In this discussion, “fixed” or “variable” are considered a local property at the station level. If the quantity of an activity consumed by a station is proportional to the quantity of activities it supplies, the associated cost is considered a variable. On the other hand, if the quantity of an activity consumed by a station is independent of the quantity of activities it supplies, the associated cost is considered fixed.

As discussed above, to represent the interrelationships among activities, or more their providers, i.e., stations, the station has to directly consume activities in addition to the supplied resources. From an economic point of view, the cost incurred at each station not only includes the cost of resources, but also includes the cost of activities. When calculating the cost driver rates for the activities that the station supplies to the other stations or products, it is necessary to take all the cost items into consideration and treat each cost item appropriately.

The system 50 shows interconnections among resources, stations and products. Each arc 60 is associated with a weight that represents the quantities of resources or activities whose unit of measure may differ depending on the output of the provider stations or resources. Resources only have outgoing arcs, while products only having incoming arcs. For cost of resources or activities that are supplied as used, such as materials and utilities, the cost driver rates are calculated based on the actual quantities, while for cost of resources or activities that are supplied in advance of usage, such as labor and lease, the cost driver rate is based on the theoretical capacity or practical capacity available. Choosing theoretical capacity or practical capacity as the denominator for computing the cost driver rates for cost incurred in advance of usage is not critical to the performance of the resulting costing system and the decision may depend on the availability of the information and the individual's preference. The key is to keep the consistency throughout.

Based on the cost driver rate, the cost of resources to stations or products can be allocated based on the quantities of cost drivers consumed. However, for cost of resources or activities supplied in advance of usage, the cost of unused capacity is left unallocated. Unallocated cost can be further allocated depending on the causes for the unused capacity. Because the purpose of the supplier-station is to support all the consumer-stations, a reasonable choice of the allocation basis can be the average activity consumption level of the consumer-stations of the same activity if it is assumed that in long term all of the consumer-stations will eventually consume some activities provided by the supplier-station. Essentially, the cost of resources or activities supplied in advance are divided into two parts, namely, a first part is consumed in a proportional manner based on the actual usage of the activities, although the cost driver rate is based on theoretical capacity or practical capacity, and a second part is the cost of unused capacity. One may notice that the allocation basis for the two parts can be different depending on the duration considered. The allocation basis for the cost of the unused capacity is chosen to be the average activity consumption levels, in the long run, the allocation bases are approximately the same. This enables the cost model being able to not only track short-term cost variations' but also provide long-term cost average.

The multi-stage cost allocation strategy provides a great flexibility in interpretation of the financial aspect of the business process and enables an analysis of the micro-level cost composition and financial performance in the rich context of interdependencies among business units.

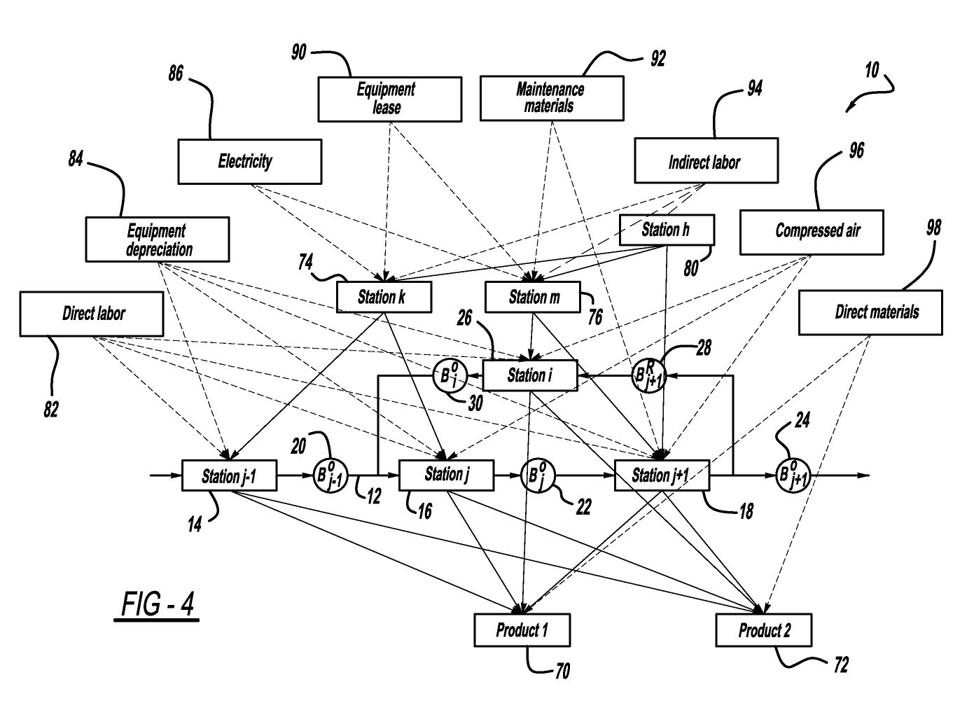

FIG. 4 shows a typical example of a cost flow model for the facility 10 shown in FIG. 1. In this example, the production stations 14, 16, 18 and 26 provide products 70 and 72, material handling station 74 provides materials to the production stations 14 and 16, material handling station 76 provides materials to the production stations 18 and 26, and maintenance station 80 provides maintenance support for the material handling stations 74 and 76 and the production station 18. Further, as represented, the following resources are allocated, where the production stations 14, 16, 18 and 26 use direct labor 82, the productions stations 14, 16, 18 and 26 have equipment depreciation 84, the material handling stations 76 and 74 use electricity 86, the material handling stations 76 and 74 have an equipment lease 90, the material handling stations 76 and 74 and the production station 18 use maintenance materials 92, the material handling stations 76 and 74 and the maintenance station 80 use indirect labor 94, the production stations 16, 18 and 26 use compressed air 96 and the products 70 and 72 use direct materials 98.

The causal relationships among the stations are indicated by the thin solid lines. Note that some productions stations not only consume resources, but also consume activities. The activity supplier-consumer relationships among stations are highlighted using thin solid lines, which are representative of the interrelationships among the stations shown in the facility 10. For example, because the maintenance station h provides maintenance supports for the production station j+1 and two other material handling stations m and k, their interrelationships are represented in the cost flow model by three outgoing arcs from station h to station j+1, k and m.

Because maintenance is station specific, the cost incurred can be conveniently traced to stations. The cost of unused capacity, such as indirect labor, needs to be further allocated to the stations because those costs have already been incurred. A natural choice of the cost driver for allocating unused capacity is the average maintenance man-hours consumed by the various stations it supported. A reasonable approximation of the average usage is the ratio:

$${r}_{j} = \frac{{MTTR}_{j}}{{MTTR}_{j} + {MTBF}_{j}}$$

Where MTTR is the meantime to repair and MTBF is the meantime between failure of a production station.

The cost incurred by unused capacity can then be allocated to the stations based on rⱼ/Σₖ rₖ.

A combination of a forklift and driver is considered as a support station in material handling, which is responsible for transporting raw materials for a number of stations usually in close geometric location. Transportation time, for example, can be used as an allocation base to assign the cost of resources including indirect labor, equipment lease and electricity to the production station it supports. Travel distance is another cost driver that can be used for cost allocation, which is largely proportional to the transportation time. The cost incurred by unused capacity, such as labor cost for the forklift drivers, for each material handling station, is further equally allocated to the stations in the same zone.

By investigating the cost flow model shown in FIG. 4 more carefully, it may be noticed that all of the costs of the direct materials flow into products directly. All other costs of resources that do not directly flow into the products are expenses incurred to keep the normal operation of the production process. This essentially leads to a natural separation between the inventory and operation expenses defined by the theory of constraint. In addition, this also excludes the cost of raw materials when evaluating the performance of each individual production station.

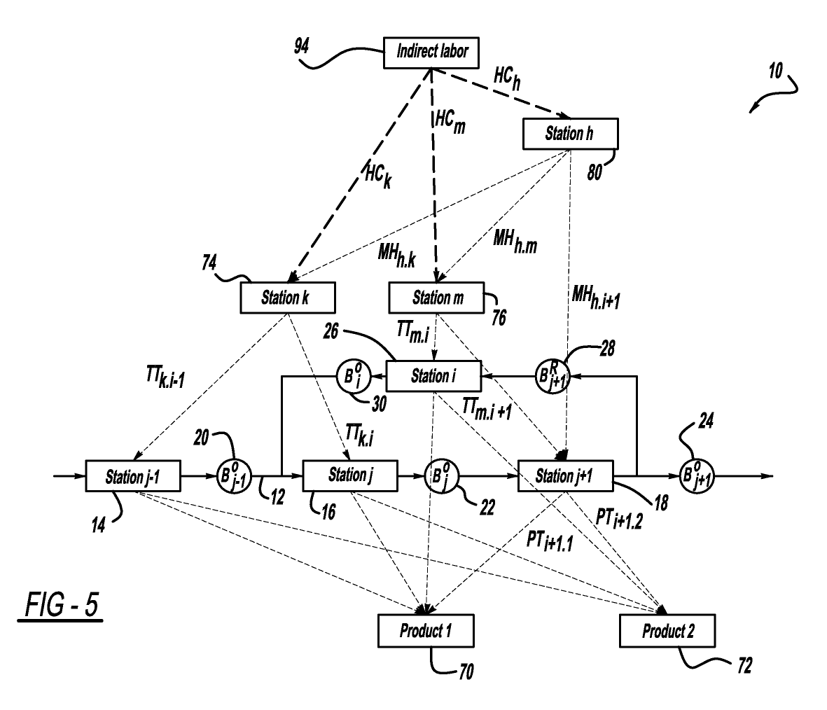

A calculation example of the cost flow from indirect labor (resources) to production stations and products along a flow path is given below in combination with FIG. 5. The cost flow of the other resources can be determined in the same manner.

For a given time period T, the costing process allocates the cost of indirect labor C^{IL}=c^{IL}T to station h, station k and station m based on head count as:

$${c}^{IL} T \frac{{HC}_{h}}{T H C} , {c}^{IL} T \frac{{HC}_{k}}{T H C} and {c}^{IL} T \frac{{HC}_{m}}{T H C}$$

Where THC is the total head count.

Further, the costing process allocates the indirect labor cost incurred by maintenance to station h, namely, Cₕ^{IL}=cₕ^{IL}THCₕ/THC, based on the accumulated man-hours for repairing each of station k, station m and station j+1 during the time period T, denoted as MH_{h,k}, MH_{h,m} and MH_{h,j+1} as follows, where the cost is treated as a fixed cost since the indirect labor is supplied in advance of usage, where even if the stations k, m and j+1 do not fail during time period T, the cost is still incurred.

Calculate the cost rate as rₕ=Cₕ^{IL}/TMHₕ, where TMHₕ is the total available man-hours of maintenance station h.

Identify the cost of used capacity as rₕMH_{h,k}, rₕMH_{h,m} and rₕMH_{h,j+1}, where MH_{h,k} is the total man-hours that maintenance station h spends on repairing station k.

Identify the cost of unused capacity by allocating the rest of the cost Cₕ^{IL}−Σ_{i=k,mj+1}rᵢMH_{h,i} based on

$$\frac{{MTTR}_{k}}{{MTTR}_{k} + {MTBF}_{k}} , \frac{{MTTR}_{m}}{{MTTR}_{m} + {MTBF}_{m}} and \frac{{MTTR}_{j + 1}}{{MTTR}_{j + 1} + {MTBF}_{j + 1}} .$$

For example, the cost of the unused capacity for station k would be:

$$( {C}_{h}^{IL} - {\sum }_{i = k , mj + 1} {r}_{i} {MH}_{h , i} ) \frac{\frac{{MTTR}_{k}}{( {MTTR}_{k} + {MTBF}_{k} )}}{\frac{{\sum }_{i = k , m , j + 1} {MTTR}_{k}}{( {MTTR}_{i} + {MTBF}_{i} )}}$$

The costing process also allocates indirect labor cost incurred by material handling station k, namely,

$${C}_{k}^{IL} = {c}^{IL} T \frac{{HC}_{k}}{T H C} + {r}_{h} {MH}_{h , k} ( {C}_{h}^{IL} - {\sum }_{i = k , mj + 1} {r}_{i} {MH}_{h , i} ) \frac{\frac{{MTTR}_{k}}{( {MTTR}_{k} + {MTBF}_{k} )}}{\frac{{\sum }_{i = k , m , j + 1} {MTTR}_{k}}{( {MTTR}_{i} + {MTBF}_{i} )}}$$

to station j and station j−1 in a fixed manner based on the accumulated time of transporting required materials to station j and station j−1 as follows.

Calculate the cost rate as rₖ=Cₖ^{IL}/TTTₖ, where TTTₖ is the total available transportation time of material handling station k.

Identify the cost of used capacity as rₖTT_{k,j} and rₖTT_{k,j-1}, where TT_{k,j} is the total time that material handling station k spends for transporting materials for production station i.

Identify the cost of unused capacity by allocating the rest of the cost Cₖ^{IL}−Σ_{i=j,mj-1}rₗTT_{k,l}. For example, if the cost of the unused capacity is allocated equally to different stations, then the cost of the unused capacity for station k would be:

$$( {C}_{h}^{IL} - {\sum }_{i = j , mj - 1} {r}_{l} {TT}_{k , l} ) \frac{1}{2}$$

Similarly, the costing process can allocate the indirect labor cost incurred at station m, namely,

$${C}_{m}^{IL} = {c}^{IL} T \frac{{HC}_{m}}{T H C} + {r}_{h} {MH}_{h , k} ( {C}_{h}^{IL} - {\sum }_{i = k , m , j + 1} {r}_{i} {MH}_{h , i} ) \frac{\frac{{MTTR}_{m}}{( {MTTR}_{m} + {MTBF}_{m} )}}{\frac{{\sum }_{i = k , m , j + 1} {MTTR}_{k}}{( {MTTR}_{i} + {MTBF}_{i} )}}$$

to station i and station j+1 as follows.

Calculate the cost rate rₘ=Cₘ^{IL}/TTTₘ, where TTTₘ is the total available transportation time of material handling station m.

Identify the cost of used capacity rₘTT_{m,i} and rₘTT_{m,j+1}, where TT_{m,i} is the total time that material handling station m spends on transporting materials for production station i.

Identify the cost of unused capacity by allocating the rest of the cost Cⱼ₊₁^{IL}−Σ_{l=i,j+1}rₗPT_{j+1,l}. For example, if the cost of unused capacity is allocated equally to different stations, then the cost of the unused capacity for station k would be:

$$( {C}_{m}^{IL} - {\sum }_{l = i , j + 1} {r}_{l} {TT}_{m , l} ) \frac{1}{2}$$

The costing process can also allocate the indirect labor cost from production stations to products, such as allocating the indirect labor cost allocated to production station j+1, namely,

$${C}_{j + 1}^{IL} = {r}_{m} {TT}_{m , j + 1} + ( {C}_{j + 1}^{IL} - {\sum }_{l = i , j + 1} {r}_{l} {TT}_{m , l} ) \frac{1}{2} + {r}_{h} {MH}_{h , j + 1} ( {C}_{h}^{IL} - {\sum }_{i = k , m , j + 1} {r}_{i} {MH}_{h , i} ) \frac{\frac{{MTTR}_{j + 1}}{( {MTTR}_{j + 1} + {MTBF}_{j + 1} )}}{\frac{{\sum }_{i = k , m , + 1} {MTTR}_{k}}{( {MTTR}_{i} + {MTBF}_{i} )}}$$

to product 1 based on the accumulated processing time for each product as follows.

Calculate the cost rate rⱼ₊₁=Cⱼ₊₁^{IL}/TPTⱼ₊₁, where TPTⱼ₊₁ is the total available production time of station j+1.

Identify the cost of the used capacity rⱼ₊₁PT_{j=1,l} and rⱼ₊₁PT_{j+1,2}, where PT_{j+1,1} is the actual processing time of station j+1 for product 1.

Identify the cost of unused capacity by choosing to allocate the rest of the cost Cⱼ₊₁^{IL}−Σ_{j=1,2}rₗPT_{j+1,l} based on PT₁ and PT₂, where:

$$( {C}_{j + 1}^{IL} - {\sum }_{l = 1 , 2} {r}_{l} {PT}_{j + 1 , l} ) \frac{{PT}_{j + 1 , 1}}{{PT}_{j + 1 , 1} + {PT}_{j + 1 , 2}}$$

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for identifying cost flow and allocation from resources to processes and products, said method comprising:
identifying production activities that directly contribute to the completion of a product and supporting activities that do not directly contribute to the completion of the product, but are essential for normal operation of a production process;
identifying stations that consume resources, consume activities and supply activities;
identifying a plurality of resources that are provided to one or more of the stations;
identifying the resources from the plurality of resources that are used as needed and the resources that are supplied in advance of being used;
allocating costs for each resource to each station that the resource supplies; and
determining the cost that each station and product uses based on the allocations.

2. The method according to claim 1 wherein identifying stations includes identifying production stations, maintenance stations and material handling stations.

3. The method according to claim 1 wherein the plurality of resources include direct labor, equipment depreciation, electricity, equipment lease, maintenance materials, indirect labor, compressed air and direct materials.

4. The method according to claim 1 wherein allocating costs for each resource to each station includes calculating a cost rate, calculating a cost of used capacity and calculating a cost of unused capacity.

5. The method according to claim 1 wherein the method employs a multi-stage cost allocation strategy.

6. The method according to claim 1 further comprising providing an interface with real-time production information, wherein allocating costs for each resource includes using the real-time production information.

7. The method according to claim 1 wherein allocating costs for each resource includes determining an average usage for allocating unused capacity as the average maintenance man-hours consumed by a station.

8. The method according to claim 1 wherein the method for identifying cost flow and allocation is used for a manufacturing system on a plant floor.

9. A method for indentifying a cost flow from resources to processes and products in a manufacturing facility, said method comprising:
identifying production activities that directly contribute to the completion of a product and supporting activities that do not directly contribute to the completion of the product, but are essential for normal operation of a production process;
identifying production stations, maintenance stations and material handling stations that consume resources, consume activities and supply activities;
identifying a plurality of resources that are provided to one or more of the stations, wherein the plurality of resources include direct labor, equipment depreciation, electricity, equipment lease, maintenance materials, indirect labor, compressed air and direct materials;
identifying the resources from the plurality of resources that are used as needed and the resources that are supplied in advance of being used;
allocating costs for each resource to each station that the resource supplies, wherein allocating costs for each resource to each station includes calculating a cost rate, calculating a cost of used capacity and calculating a cost of unused capacity; and
determining the cost that each station and product uses based on the allocations.

10. The method according to claim 9 wherein allocating costs for each resource includes calculating the cost rate based on available man hours, calculating the cost of used capacity based on total man hours and calculating the cost of unused capacity based on average man-hours consumed.

11. The method according to claim 9 wherein allocating costs for each resource includes calculating the cost rate based on total available transportation time, calculating the cost of used capacity based on the total time that a material handling station spends on transporting materials for production stations and calculating the cost of unused capacity equally to different stations.

12. The method according to claim 9 wherein allocating costs for each resource includes calculating the cost rate based on total available production time of a product station, calculating the cost of unused capacity as the actual processing time of a production station and calculating the cost of unused capacity based on production time.

13. The method according to claim 9 wherein allocating costs for each resource includes allocating the cost based on head count.

14. A system for indentifying a cost flow from resources to processes and products, said system comprising:
means for identifying production activities that directly contribute to the completion of a product and supporting activities that do not directly contribute to the completion of the product, but are essential for normal operation of a production process;
means for identifying stations that consume resources, consume activities and supply activities;
means for identifying a plurality of resources that are provided to one or more of the stations;
means for identifying the resources from the plurality of resources that are used as needed and the resources that are supplied in advance of being used;
means for allocating costs for each resource to each station that the resource supplies; and
means for determining the cost that each station and product uses based on the allocations.

15. The system according to claim 14 wherein the means for identifying stations identifies production stations, maintenance stations and material handling stations.

16. The system according to claim 14 wherein the plurality of resources include direct labor, equipment depreciation, electricity, equipment lease, maintenance materials, indirect labor, compressed air and direct materials.

17. The system according to claim 14 wherein the means for allocating costs for each resource to each station calculates a cost rate, calculates a cost of used capacity and calculates a cost of unused capacity.

18. The system according to claim 17 wherein the means for allocating costs for each resource calculates the cost rate based on available man hours, calculating the cost of used capacity based on total man hours and calculating the cost of unused capacity based on average man-hours consumed.

19. The system according to claim 17 wherein the means for allocating costs for each resource calculates the cost rate based on total available transportation time, calculating the cost of used capacity based on the total time that a material handling station spends on transporting materials for production stations and calculating the cost of unused capacity equally to the stations.

20. The system according to claim 17 wherein the means for allocating costs for each resource calculates the cost rate based on total available production time of a product station, calculating the cost of unused capacity as the actual processing time of a production station and calculating the cost of unused capacity based on production time.
